(19) United States
(12) Patent Application Publication
(10) Pub. No.: US 2011/0020772 A1
(43) Pub. Date: Jan. 27, 2011

(54) KIT AND METHOD FOR MAINTAINING PERSONAL WELLNESS

(76) Inventors: Wesley Carter, Annapolis, MD (US); Stephanie Petrella, Newark, DE (US)

Correspondence Address: OBER / KALER;C/O ROYAL W. CRAIG, 120 EAST BALTIMORE STREET, SUITE 800, BALTIMORE, MD, 21202, US

(21) Appl. No.: 12/823,813

(22) Filed: Jun. 25, 2010

Related U.S. Application Data
(60) Provisional application No. 61/269,499, filed on Jun. 25, 2009.

(51) Int. Cl. G09B 19/00; A47G 19/02; B65D 23/00

(52) U.S. Cl. 434/127; 220/575; 215/365

(57) ABSTRACT

A wellness method, system and kit for preventing and delaying chronic diseases. In an embodiment, the wellness kit comprises stepped portions reduction and control plates, a water bottle, an elastic stretching band, a pedometer, a food and exercise log, wellness cards, a tape measure, and multimedia health information and instruction. The sequentially administered portion reduction and control plates are designed to control and reduce portion size consumption to a targeted portion size by using stepped portion reductions to normalize the reduced size. The water bottle provides visual indication of the number of bottles consumed while the stretching band increases flexibility and circulation by providing a variable resistance to a wide range of motion. To encourage physical activity and good nutrition a pedometer and a food and exercise log is used to record the use of the other tools in the method and kit. For quick reference to health information and instruction, wellness cards are included as well as a multimedia information and instruction embodied on a compact disc.

### CROSS-REFERENCE TO RELATED APPLICATIONS

The present application derives priority from U.S. Provisional Patent Application 61/269,499 filed: Jun. 25, 2009 which is incorporated herein by reference.

### BACKGROUND OF THE INVENTION

1. Field of the Invention

The present invention is generally directed to personal health and wellness and more specifically to an improved collection of tools and resources that promote personal health and wellness by specifically targeting chronic diseases.

2. Description of the Background

Chronic diseases are prolonged, noncommunicable illnesses that do not resolve spontaneously and are rarely cured completely. Common examples of chronic diseases include heart disease, cancer, stroke, diabetes, arthritis, hypertension, pulmonary conditions, and emotional disorders. In the United States, chronic diseases cause seven in ten deaths each year, and about 133 million Americans live with at least one chronic disease. Chronic diseases affect our healthcare system as more than seventy-five percent of all health care cases are attributed to chronic diseases, and employers feel the effect of chronic diseases through increased labor costs. Chronic diseases increase healthcare costs while decreasing productivity through absenteeism (missing work), presenteeism (decreased on-the-job effectiveness), and employee turnover. These labor costs can consume over half of the corporate profits. Not surprisingly, chronic diseases are now recognized as a leading health concern of the United States that needs a comprehensive approach to prevention.

Although chronic diseases are the most costly health problems, they are also the most preventable. The most common causes of these chronic diseases include common lifestyle choices such as lack of physical activity, poor nutrition, tobacco use, and excessive alcohol consumption. Physical activity helps control weight; reduces risks for cardiovascular disease, type 2 diabetes, and some cancers; strengthens bones and muscles; and improves mental health and mood. Good nutrition helps lower the risk for chronic diseases such as heart disease, stroke, diabetes, and osteoporosis. For example, increased fruit and vegetable consumption reduces the risk for heart disease and certain cancers. Smoking is the most avoidable cause of disease, disability, and death, and excessive alcohol consumption is the third leading life-style cause of death. Thus, daily lifestyle choices such as consumption of smaller food portions, drinking more water, and exercising more can add up to huge results for employers—healthier employees, reduced absenteeism, and reduced presenteeism.

### SUMMARY OF THE INVENTION

Accordingly, it is an object of this invention to provide a wellness kit and method of use that prevents and delays chronic diseases and provides real tools to educate and motivate individuals to methodically make healthier everyday choices and prevent and delay chronic diseases

Another object is to provide a wellness kit that employers can distribute to their employees to encourage healthy lifestyles by the disclosed method and thus prevent chronic diseases.

Yet another object is to provide a wellness kit that specifically targets heart diseases, diabetes, pulmonary conditions, hypertension, emotional disorders, stroke, and cancer.

Still yet another object is to provide a wellness kit that prevents and delays chronic diseases through education, individual awareness, physical activity, and good nutrition.

These and other objects are accomplished with a wellness kit in accordance with the exemplary embodiments of the present invention.

An exemplary wellness kit comprises stepped portion reduction plates, with measurements and food group choices embossed on rim of plates, a water bottle with function of keeping track of total amount of water consumed, a stretch band, a pedometer, a journal with food and exercise log, healthy tips, and chronic disease management information, wellness tips cards with portion size information and chronic disease information such as glycemic index, and a measuring tape with BMI information. The individual components may be packaged together in a compact and efficient manner for easy distribution to users such as a company's employees. The portion plates are designed to educate and give individuals real tools to understand their target portion size and reduce portion sizes gradually to reach their own personal target. The portion reduction plates provide plates with food wells that become smaller on each consecutive plate. The food group choice and food well measurement is embossed around the edge of each portion plate. The plates are a tool to reduce food portion size gradually and also serve as an educational tool to show which food group is associated with the measurement. The largest well on each plate is for Vegetables, Salad and Fruit, the medium well on each plate corresponds to Whole Grains, Rice, and Beans and the smallest well on each plate corresponds to Fish, Poultry, Beef, Tofu. Optionally, each plate has a corresponding lid that fits tightly around the plate's perimeter, creating a leak proof seal, and each lid nests with the stepped lid immediately before and after it.

The water bottle allows for quick and easy measurement of water consumption. In one embodiment the water bottle generally comprises a water container and a lid assembly. The water container holds water and allows measurements by using a graduated scale on the container's side. The lid assembly comprises a cap, an indicator ring, and a spout. The cap attaches to the container's aperture. The cap has a hollow cylindrical nipple that protrudes upward and has a plurality of axially-aligned ridges on the exterior surface. The cap also has a numeric scale concentrically aligned around the nipple. The indicator ring fits around the outside of the nipple and has a plurality of ridges that cooperatively engage with nipple's exterior ridges. The cooperative engagement allows for incremental rotation of the indicator ring, but not free rotation. The indicator ring also has an indicator for indentifying a specific value on the cap's numeric scale. The spout fits within the nipple and thereby overlaps the indicator ring, securing the ring to the nipple. When assembled, the ring may be incrementally rotated to align the indicator with a value on the numeric scale that corresponds to the amount of bottles consumed.

The stretch band comprising an elastic loop or strand is included for increasing flexibility and promoting good circulation. The stretch band is used to apply variable resistance to muscle movements or isolated stretching. To encourage increased physical activity, the wellness kit also includes a pedometer. The pedometer continuously tracks ones current activity and provides a reminder to be active. The daily food and exercise log maintains a record of caloric intake and loss (exercise), which shows daily habits and encourages healthier choices. The wellness tips cards are a set of bound cards having valuable health information, portion size guides and references, glycemic index and instruction and which serve as a quick reference tool. A BMI tape measure may also be included in the wellness kit to obtain the necessary measurements to determine a user's body mass index. The critical BMI zones are imprinted on the tape. The wellness kit may include multimedia health information and instruction embodied on a compact disc (or other medium) to provide an alternative communication medium for relaying health information and instruction.

The tools of the wellness kit support and enhances the patient centric approach of the Wagner Care Model for Chronic Disease Management as well as many other wellness programs. The Wagner model views the patient as the primary care giver because it is the patient that makes the important daily decisions of what to consume, how much to exercise and whether to comply with medication regimens and schedules. By providing real tools that the patients/individuals can use each day, the kit greatly improves the chances of progress and success in combating chronic disease over simply providing printed educational material and/or lectures. The impact of holding the portion reduction plates on the patient is quite dramatic when that person realizes how far off their daily consumption and food group choices are from the norm. The real tools support the concept of a higher retention by providing a physical experience along with the traditional approach of printed educational materials

The above and other objects, features and advantages of the present invention will become readily apparent from the following detailed description thereof which is to be read in connection with the accompanying drawings.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of a packaged wellness kit having portion plates, a water bottle, a stretch band, a pedometer, a food and exercise log, wellness cards, a measuring tape, and multimedia instruction and information.

FIG. 2 is perspective view of the tools utilized under the present invention absent the kit assembly of FIG. 1

FIG. 3 is a perspective view of the portion plates and optional lids in an unnested position (FIG. 3A) and a nested position (FIG. 3B).

FIG. 4 is a side view of a portion plate with its optional lid attached (FIG. 4A) and a top view of nested portion plates (FIG. 4B).

FIG. 5 is a perspective view of a water bottle.

FIG. 6 is a perspective view of a food and exercise log and wellness cards.

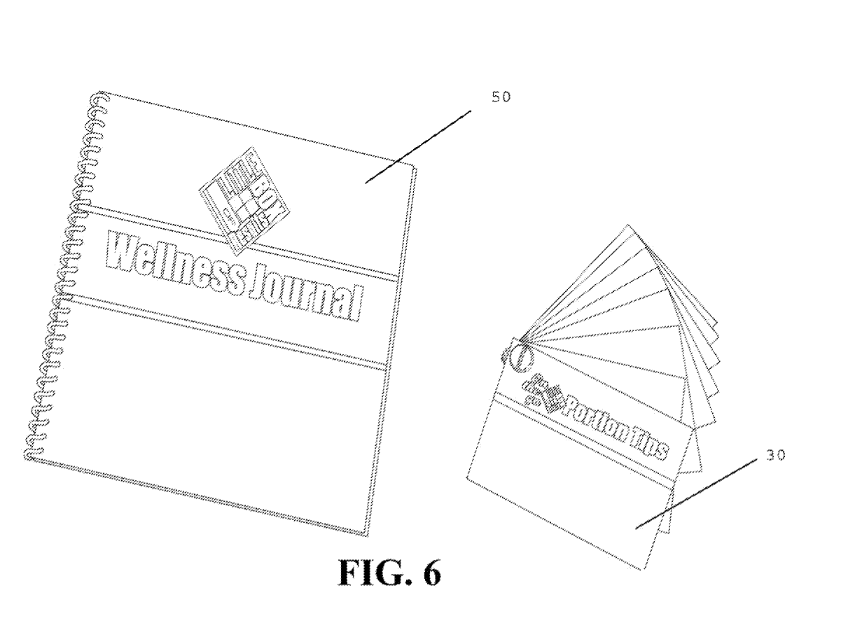

FIG. 7 is perspective view of the portion reduction and control plates of the present invention.

FIG. 8 is an exploded perspective view of the nested portion reduction and control plates of the present invention.

FIG. 9 is a perspective view of an alternate embodiment of the present invention targeting diabetic users.

### DETAILED DESCRIPTION OF THE PREFERRED EMBODIMENTS

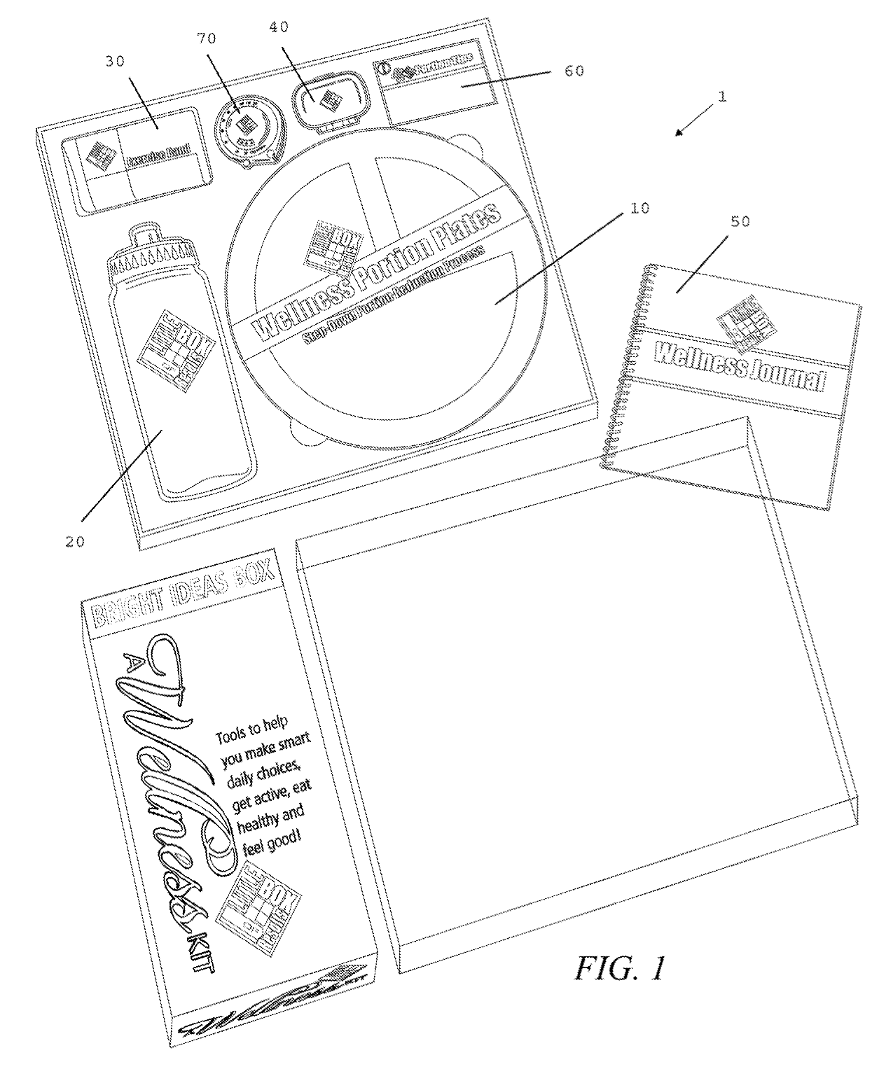

The present invention is a multifaceted approach and method utilizing tools that make poor behavioral choices by the individual practitioner more apparent and difficult to deny while also recording and highlighting desirable behavioral choices. The present invention is further directed to a kit of such tools to be utilized in conjunction with the disclosed method. With reference to the figures, and in particular to FIG. 1, an embodiment of the present invention is a health and wellness kit 1 that comprises portion plates 10, a water bottle 20, a stretch band 30, a pedometer 40, a food and exercise log 50, wellness cards 60, a measuring tape 70, and multimedia instructions and information 80 for utilization in conjunction with the inventive method. The wellness kit 1 is specifically designed to prevent chronic diseases such as cancer, diabetes, hypertension, stroke, heart disease, pulmonary conditions, and emotional disorders. In the illustrated embodiment, the individual components are packaged together in a compact and efficient manner for easy distribution to users.

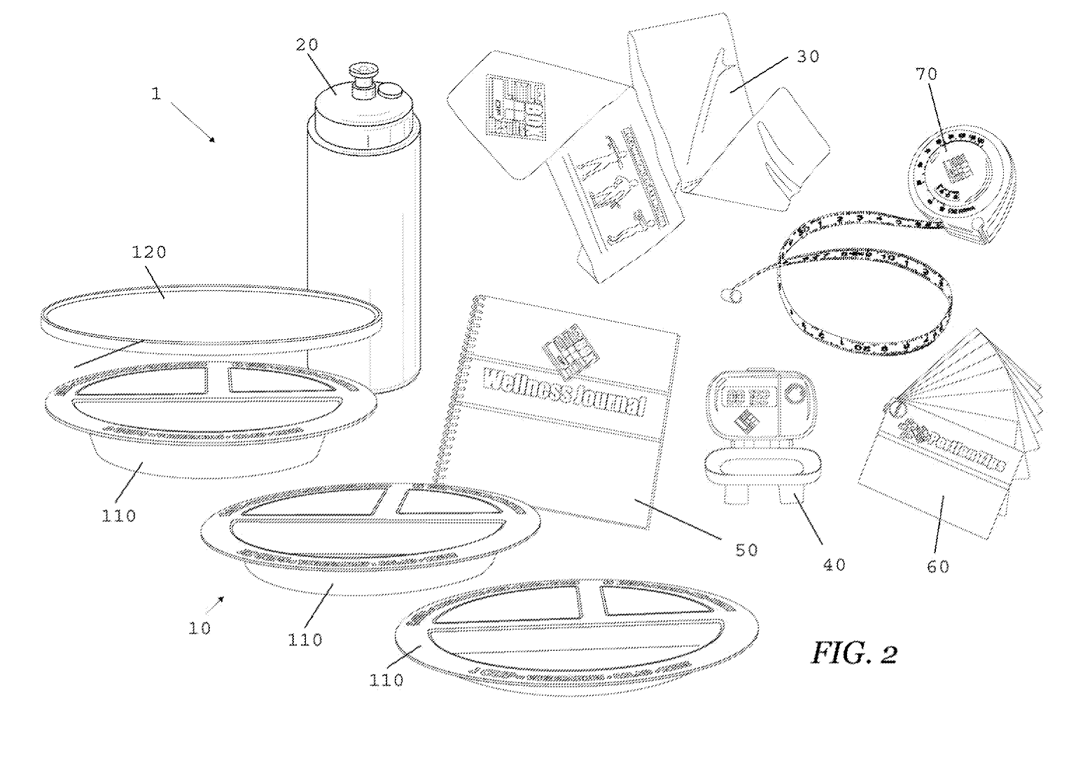

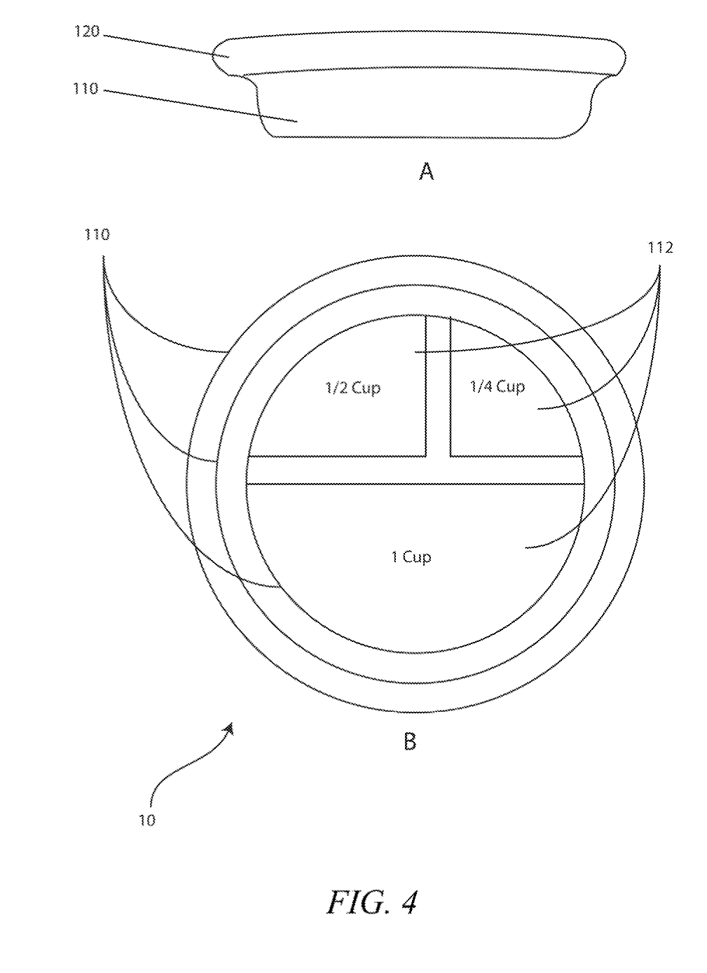

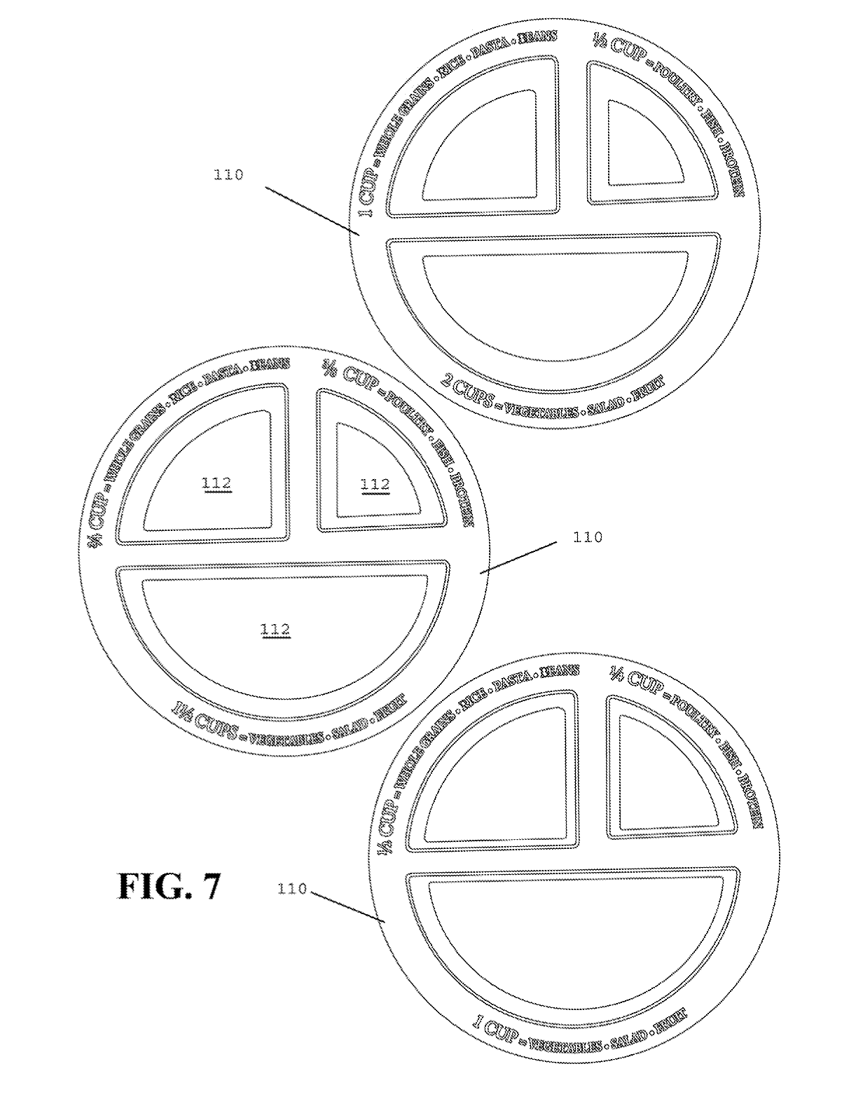

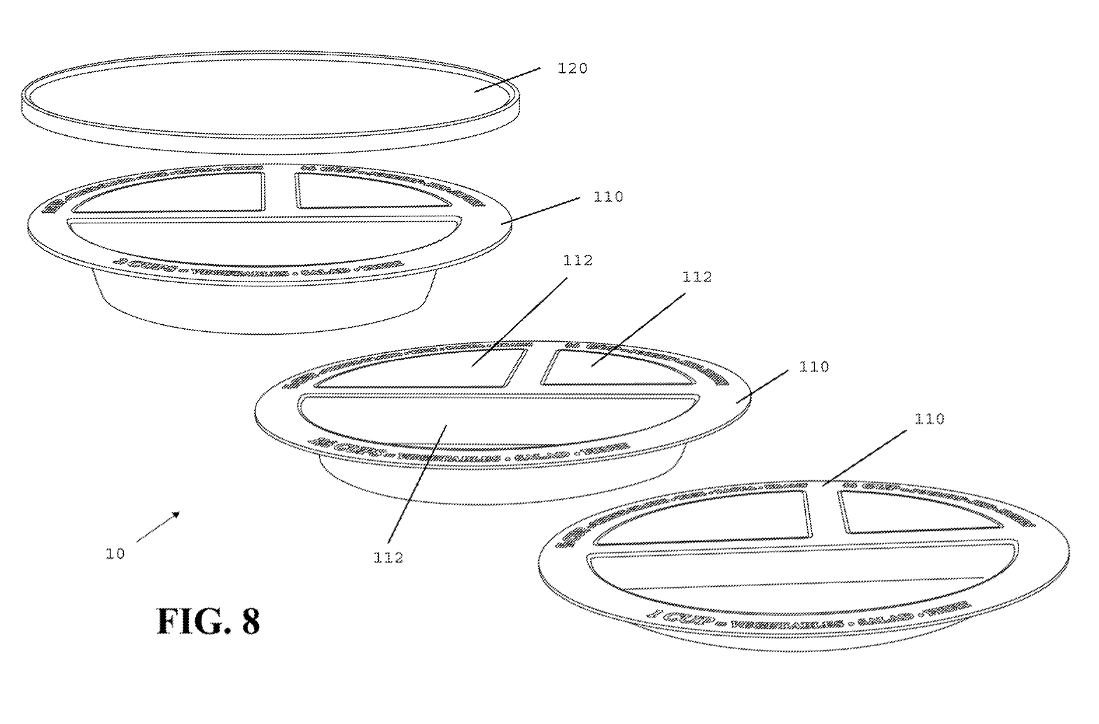

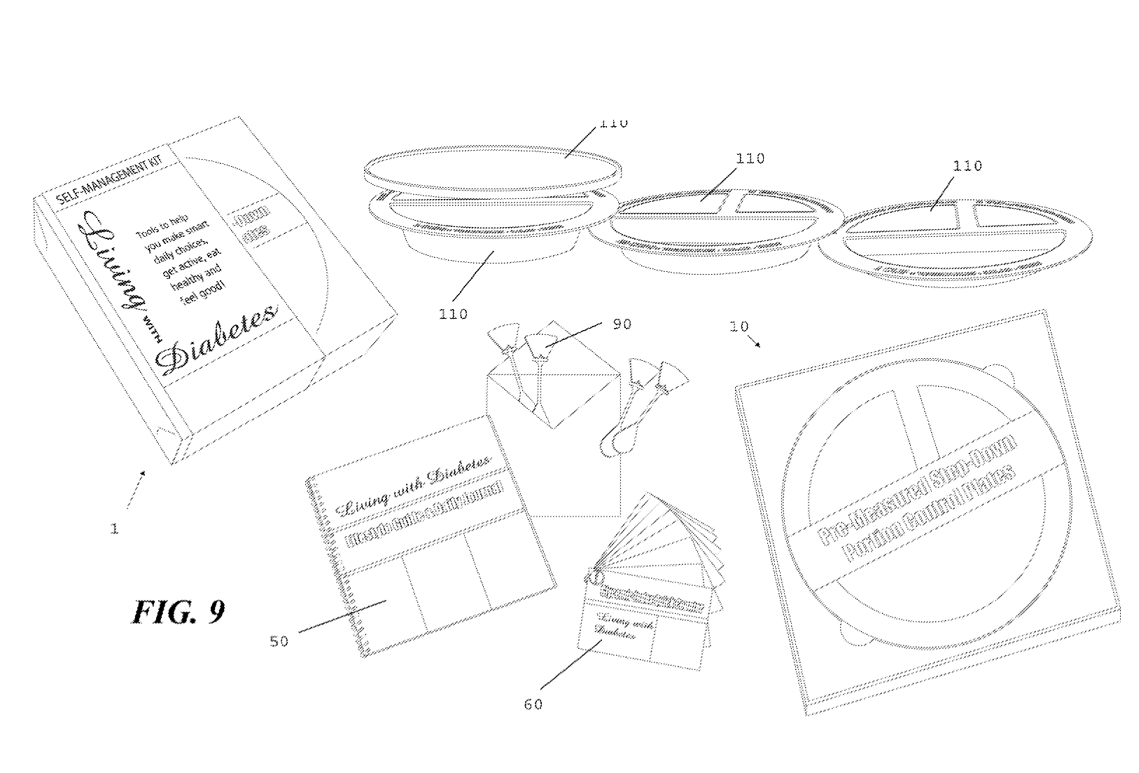

Referring collectively to FIGS. 2, 3 and 4 and 7-9, the wellness kit 1 includes portion plates 10. The portion plates 10 are made up of a set of multiple plates 110 that measure portion size and are sequentially administered to reduce the “normal” portion size as judged by the user to a healthier, more realistic size. Each plate 110 is demarcated by lines on the plate's eating surface or, preferably, physically divided into a series of wells or food compartments 112. A demarcated section or compartment 112 is provided to measured the portion size of food in a specific food group or type. For example, in a preferred embodiment, three food compartments 112 are provided in which the first is designated for vegetables, fruits and salad; the second is provided for whole grains, rice, beans and pasta; and the third is provided for poultry, fish or other protein sources such as lean meat or tofu.

The surface of each plate 110 is marked or embossed adjacent to each compartment 112 to indicate the food type to be plated in that compartment along with the portion size for that food type for the given plate 110. The series of plates 110 are used sequential to incrementally reduce the portion size of one or more food types by reducing the indicated portion size along with an concomitant reduction in the demarcated area allotted for a given food type between subsequent plates. Where a physical separation is provided between compartments the portion size permitted in a particular compartment may be reduced by a reduction in the depth of the well while the areal allotment of the plate to the particular food type is unchanged. In certain embodiments, the portion size of all food types may be reduced while in other embodiments only one or some portion sizes may be reduced while others are maintained or even increased.

In the illustrated embodiment, the portion plates 10 utilize a three-step, three-plate 110 process in which a beginner, intermediate and target plate 110 are each sequentially administered to reach the targeted portion sizes for three categories of food. The configuration of food wells remains constant between the three plates 110 although the well depth is decreased to effectuate a change on the allowed portion size and thus the portion perceived as “normal” by the user. The beginner plate provides portion sizes of approximately 2 cups, 1 cup and ½ cup for salad, fruits and vegetables, starches and grains, and proteins, respectively. The intermediate plate provides portion sizes of approximately 1½ cups, ¾ cup and ⅜ cup for salad, fruits and vegetables, starches and grains, and proteins, respectively The targeted portion plate provides portion sizes of approximately 1 cup, ½ cup, and ¼ cup for salad, fruits and vegetables, starches and grains, and proteins, respectively. Each plate is sequentially administered (i.e. used) for one or more meals each day for a predetermined period ranging from days to weeks in order for the user to become sensitized to the size of the food portions consumed and to normalize the new size. This incremental stepped reduction and normalization process makes it more likely that the user will continue consuming smaller portion sizes for a prolonged duration.

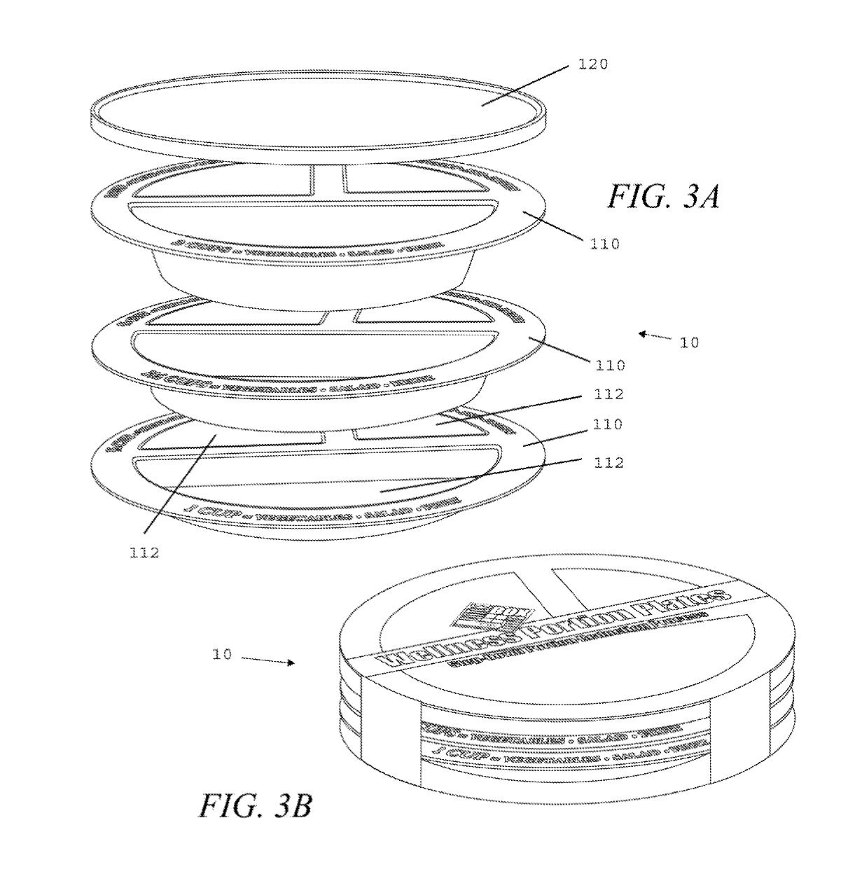

For compact and efficient storage, each individual plate 110 nests with the stepped plate immediately before and after it—the food compartments 112 and their corresponding partition walls nest with the other plates' food compartments and partition walls. Additionally, a lid 120 is provided that fits tightly around each plate's perimeter, creating a leak proof seal, for easy transport of the plate and further limiting the user's ability to simply heap food into a particular compartment and overfill it beyond the allotted portion. To prevent the separate food items from mixing, the lid may also fit tightly around the partition walls. FIG. 3B illustrates the plates 110 nested together and the lids 120 nested together and stacked on top of the nested plates.

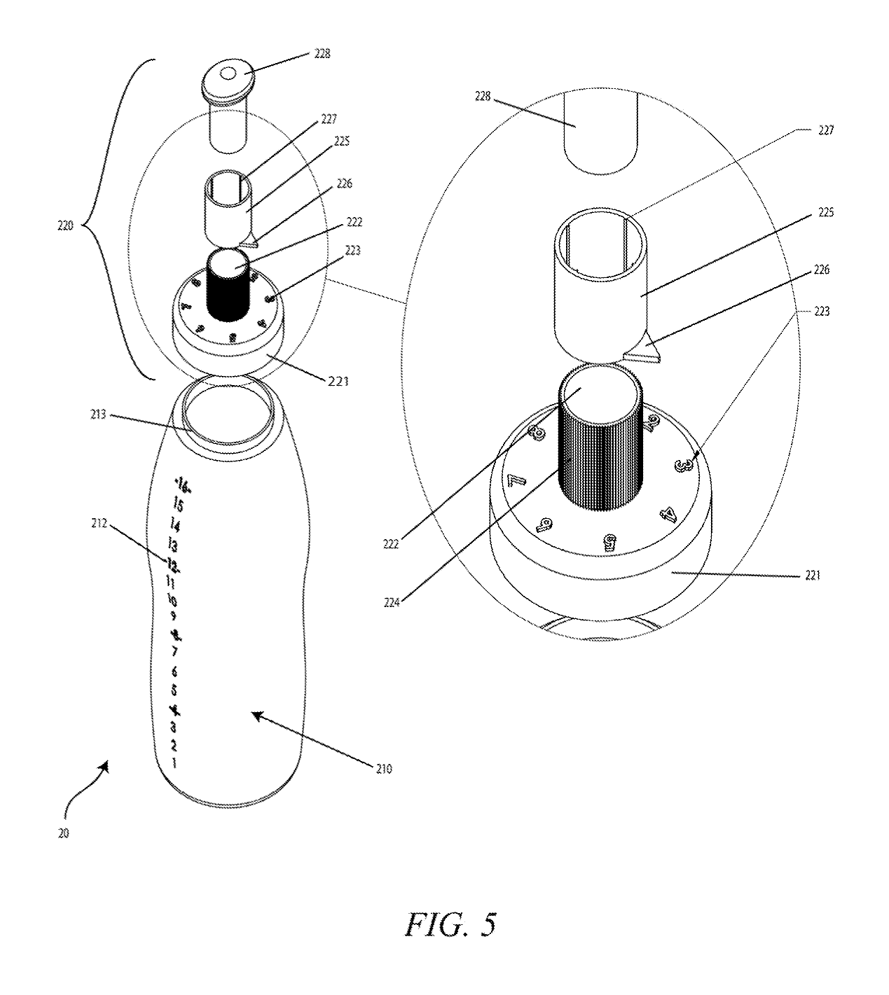

Referring to FIG. 5, the wellness kit 1 may also comprise a water bottle 20 that allows ready water consumption and for quick and easy water measurement and tracking of the consumed amount. The water bottle 20 of the present invention helps ensure that the user drinks a healthy amount of water every day which is a significant factor in healthy eating. In an embodiment, the water bottle 20 generally comprises a water container 210 and a lid assembly 220. The water container 210 is preferably manufactured from any translucent polymeric material that allows intake measurements of a single bottle using a scale 212 on the container's side. The container's top has an aperture with an upwardly protruding lip 213.

In an embodiment, the lid assembly 220 comprises a cap 221, an indicator ring 225, and a spout 228. The cap 221 attaches to the container 210 by cooperatively engaging with the container's lip 213, forming a water tight seal. For example, cap 221 may have internal threads that cooperatively engage with external threads on the lip 213. The cap 221 has a hollow cylindrical nipple 222 protruding upward for passing water through the cap 221. A plurality of axially-aligned ridges 224 are formed on the nipple's exterior surface. The cap 221 also has a numeric scale 223 concentrically aligned around the nipple 222.

The indicator ring 225 is a cylindrical tube sized to fit around the outside of nipple 222. The indicator ring's interior surface has a plurality of ridges 227 that cooperatively engage with nipple's exterior ridges 224 to prevent the indicator ring 225 from freely rotating around nipple 222 while still allowing incremental rotation when adequate force is applied. The indicator ring 225 comprises an indicator to identify a specific value on numeric scale 223. In the illustrated embodiment, the indicator 226 is a triangle that radially points outward. The spout 228 cooperatively engages with the interior surface of the nipple 222. The spout 228 may pressure fit within the nipple 222 or the spout may have external threads that engage with internal threads on the nipple. The spout 228 has a lip that overlaps the indicator ring 225, holding the ring in place around the nipple 222. When assembled, the ring 225 may be selectively and incrementally rotated to align the indicator 226 with a specific value of the numeric scale 223 that corresponds to the number of bottles consumed.

The wellness kit 1 may also comprise a stretch or resistance training band 30 for increasing flexibility and promoting good circulation. The stretch band 30 may comprise elongated elastic tubing or elongated flat elastic bands and may form a continuous loop or a discontinuous strand. The stretch band is wrapped around the body or its extremities to produce ranges of motion that are subject to variable resistance and active-isolated stretching. In addition to increasing flexibility and promoting good circulation, the stretch band is effective for injury rehabilitation and weight training.

A pedometer 40 may also be included in the wellness kit 1. A pedometer 40 is a known portable electronic or electromechanical device that counts each step a person takes by detecting the body's motion. A pedometer 40 can continuously track a user's current physical activity in terms of the number of steps taken in a given period, usually a day, and acts as an environmental cue that reminds people to be active. If the pedometer 40 is used in combination with record keeping, it is an effective way to increase daily physical activity. Any pedometer device currently known in the art is suitable for the wellness kit 1.

The wellness kit 1 also includes wellness cards 60. The wellness cards 60 are a set of cards bearing a variety of valuable health information and instruction such as food portion references and BMI charts. The wellness cards 60 are sized to easily fit within a purse or briefcase for easy reference anywhere and are preferably bound together to ensure easy organization and storage. By way of example, wellness cards 60 may provide visual comparisons of food portions sizes to well known household items. A 6 oz. baked potato is approximately the same size as a typical computer mouse while a 3 oz. portion of chicken is approximately equivalent in size to a deck of standard playing cards. Providing quick and easy reference to real world references for portion sizes helps user's make better portion choices either in conjunction with plates 10 or when plates 10 are unavailable. In certain embodiments the wellness cards 60 may be provided in electronic form as in an application for a smart phone or similar portable electronic device.

The wellness kit 1 may include multimedia information and instruction 80. In the illustrated embodiment, the multimedia information and instruction 80 is embodied on a compact disc, but the multimedia instruction 80 may be embodied on any medium including written documentation, computer multimedia, video, audio or any combination of the same. The multimedia information and instruction 80 provides an alternative medium to relay information to the user and may include additional health tips, inspiration, and educational information.

A tape measure 70 may also be included in the wellness kit 1. The tape measure 70 is preferably a fabric tape measure or other flexible tape measure suitable for measuring the human body and comprise any flexible substrate such as a strip of cloth, plastic, fiber glass, or metal having linear measurement markings. Regular measurement of body dimensions allows a kit user to determine a their body mass index or percentage body fat using various calculations provided in the food and exercise log 50 as described below. In another embodiment of the invention, Neuropathic testers may be included as a tool to determine sensitivity and address the critical need for early detection in individuals at risk for diabetes. Diabetic neuropathy refers to a group of nerve disorders caused by diabetes, pre-diabetic conditions or low blood sugar. Diabetic neuropathy can affect nerves throughout the body although it most commonly affects nerves in the feet and legs. A screening test to check point sensation in the feet can be done at home to detect neuropathic conditions. The test uses a nylon filament mounted on a small wand. The filament delivers a standardized 10-gram force when touched to areas of the foot. Patients who cannot sense pressure from the filament have lost protective sensation and are at risk for developing neuropathic foot ulcers.

A daily food and exercise log 50 is included in an embodiment of the wellness kit 1 for recording use of the other tools in the kit and the caloric intake and weight loss of the user. In the depicted embodiment the log 50 is a physical book of paper that prompts a user for entry of daily meals consumed and relative portion sizes, the quantity of water consumed as recorded by the water bottle 20 or otherwise consumed, the amount of physical exercise performed in terms of the number of steps recorded by the pedometer 40 or other targeted exercise regimens. The log may further periodically prompt the user for entry of body dimensions including weight in order to calculate BMI and body fat percentage. The log 50 allows the user to track daily habits and calls attention to failures and successes which allows the user to make healthier choices over the long term. The log 50, like the other tools in the kit, serves as an environmental cue that reminds people to make healthy food choices, drink water, and exercise. In certain embodiments the log 50 may be provided in electronic form as in an application for a smart phone or similar portable electronic device. Such an electronic application would automate certain calculations and data entry as well as prompt the user to enter information on an appropriate schedule.

Other variations are within the spirit of the present invention including variations that omit one or more elements of the exemplary kit. Thus, while the invention is susceptible to various modifications and alternative constructions, a certain illustrated embodiment thereof is shown in the drawings and has been described in detail. It should be understood that there is no intention to limit the invention to the specific form or forms disclosed. Rather, variations to the preferred embodiments will become apparent to those skilled in the art upon reading the forgoing disclosure and it is the intention of the inventor to cover all such modifications and alternate constructions falling within the spirit and scope of the invention.

I claim:

1. A wellness kit for preventing, delaying and improving chronic conditions in an individual, comprising:
a plurality of sequentially administered portion reduction and control plates, said plates comprising:
a plurality of physically segregated food compartments; and
a label adjacent to each of said food compartments indicative of the intended type and quantity of food to be plated in said food compartment;
wherein each of said plurality of plates is provided with the same configuration of physically segregated food compartments; and
wherein the relative size of any one of said plurality of food compartments is incrementally changed between each successively administered plate;
a water bottle, said water bottle comprising a visual indication of the volume of water that has been consumed from the bottle, and a visual indication of the number of times the bottle has been consumed in its entirety;
an elastic resistance band for improving strength, flexibility, and circulation;
a pedometer;
at least one medium for providing multimedia inspiration, instruction, and education; and
a food and exercise log book for recording use of said portion reduction and control plates, water bottle, resistance band or pedometer.

2. The wellness kit of claim 1, wherein said plurality of physically segregated food compartments comprises three food compartments.

3. The wellness kit of claim 2, wherein
said label adjacent to a first of said three physically segregated food compartment indicates said intended food type to be vegetables, fruits or salad;
said label adjacent to a second of said three physically segregated food compartment indicates said intended food type to be whole grains, rice, pasta or beans;
said label adjacent to a third of said three physically segregated food compartment indicates said intended food type to be poultry, fish or protein.

4. The wellness kit of claim 1, wherein said incremental change in the relative size of any one of said plurality of food compartments is an incremental reduction in size.

5. The wellness kit of claim 1, further comprising a tape measure for measuring said individual's body; and wherein said food and exercise log further comprises a means for recording said body measurements and determining the body mass index of said individual.

6. The wellness kit of claim 1 wherein said plurality of sequentially administered portion reduction and control plates comprises three portion reduction and control plates.

7. The wellness kit of claim 6 wherein
a first sequentially administered portion reduction and control plate comprises:
a first physically segregated food compartments sized to contain food portion of substantially two cups;
a second physically segregated food compartments sized to contain food portion of substantially one cup; and
a third physically segregated food compartments sized to contain food portion of substantially one half cup.

8. The wellness kit of claim 7 wherein
a second sequentially administered portion reduction and control plate comprises:
a first physically segregated food compartments sized to contain food portion of substantially one and one half cups;
a second physically segregated food compartments sized to contain food portion of substantially three quarters of a cup; and
a third physically segregated food compartments sized to contain food portion of substantially three eighths of a cup; and
a third sequentially administered portion reduction and control plate comprises:
a first physically segregated food compartments sized to contain food portion of substantially one cup;
a second physically segregated food compartments sized to contain food portion of substantially one half cup; and
a third physically segregated food compartments sized to contain food portion of substantially one quarter of a cup.

9. A method of promoting behaviors that tend to prevent, delay and improve chronic conditions in an individual, comprising the steps of:
providing a plurality of sequentially administered portion reduction and control plates, said plates comprising:
a plurality of physically segregated food compartments; and
a label adjacent to each of said food compartments indicative of the intended type and quantity of food to be plated in said food compartment;
wherein each of said plurality of plates is provided with the same configuration of physically segregated food compartments; and
wherein the relative size of at least one of said plurality of food compartments is incrementally changed between each successively administered plate;
administering a first portion reduction and control plate for a predetermined period during which said individual normalizes the type and quantity of said food plated in each of said food compartments;
sequentially administering a subsequent portion reduction and control plate until such time as the type and quantity of said food plated in each of said food compartments is normalized at a target quantity; and
recording in a log the administration of said portion reduction and control plates with at least one meal per day.

10. The method of claim 9, wherein said plurality of physically segregated food compartments comprises three food compartments.

11. The method of claim 10, wherein
said label adjacent to a first of said three physically segregated food compartment indicates said intended food type to be vegetables, fruits or salad;
said label adjacent to a second of said three physically segregated food compartment indicates said intended food type to be whole grains, rice, pasta or beans;
said label adjacent to a third of said three physically segregated food compartment indicates said intended food type to be poultry, fish or protein.

12. The method of claim 9, wherein said incremental change in the relative size of any one of said plurality of food compartments is an incremental reduction in size.

13. The method of claim 9 wherein said plurality of sequentially administered portion reduction and control plates comprises three portion reduction and control plates.

14. The method of claim 9 further comprising the steps of
providing a water bottle, said water bottle comprising a visual indication of the volume of water that has been consumed from the bottle, and a visual indication of the number of times the bottle has been consumed in its entirety; and
recording in said log the quantity of water consumed per day.

15. The method of claim 9 further comprising the steps of
providing a pedometer to quantify physical activity; and
recording in said log the use of said resistance band each day.

16. The method of claim 9 further comprising the steps of
providing an elastic resistance band for improving strength, flexibility, and circulation; and
recording in said log the quantity of physical activity performed each day.

17. The method of claim 9 further comprising the steps of
providing a tape measure for measuring said individual's body; and
recording in said log the body measurements in order to regularly determine said users body mass index.

18. A system for portion reduction and control, comprising:
a plurality of sequentially administered portion reduction and control plates, said plates comprising:
a plurality of physically segregated food compartments; and
a label adjacent to each of said food compartments indicative of the intended type and quantity of food to be plated in said food compartment;
wherein each of said plurality of plates is provided with the same configuration of physically segregated food compartments; and
wherein the relative size of at least one of said plurality of food compartments is incrementally changed between each successively administered plate; and
a lid for sealed engagement with any one of said plurality of portion reduction and control plates.

19. The system of claim 18 wherein said plurality of physically segregated food compartments comprises three food compartments; and
wherein said label adjacent to a first of said three physically segregated food compartment indicates said intended food type to be vegetables, fruits or salad;
said label adjacent to a second of said three physically segregated food compartment indicates said intended food type to be whole grains, rice, pasta or beans; and
said label adjacent to a third of said three physically segregated food compartment indicates said intended food type to be poultry, fish or protein.

20. The system of claim 18 wherein said plurality of sequentially administered portion reduction and control plates comprises three portion reduction and control plates; and
wherein a first sequentially administered portion reduction and control plate comprises:
a first physically segregated food compartments sized to contain food portion of substantially two cups;
a second physically segregated food compartments sized to contain food portion of substantially one cup; and
a third physically segregated food compartments sized to contain food portion of substantially one half cup.
